(19) United States
(12) Patent Application Publication
(10) Pub. No.: US 2020/0226099 A1
(43) Pub. Date: Jul. 16, 2020

(54) METHOD AND APPARATUS FOR IMPROVING HASH SEARCHING THROUGHPUT IN THE EVENT OF HASH COLLISIONS

(71) Applicants: Jyothi Vemulapalli, Hyderabad, IN (US); Ramesh B.M. Iyer, Bangalore, IN (US)

(72) Inventors: Jyothi Vemulapalli, Hyderabad, IN (US); Ramesh B.M. Iyer, Bangalore, IN (US)

(21) Appl. No.: 16/245,315

(22) Filed: Jan. 11, 2019

(51) Int. Cl. G06F 16/13; G06F 16/14; G06F 16/906; G06F 16/901

(52) U.S. Cl. CPC G06F 16/137; G06F 16/9014; G06F 16/906; G06F 16/152

(57) ABSTRACT

A hash table data structure is provided that reduces the number of DMA operations, and if possible, the number of key comparisons, needed to traverse the table entries to find an entry that matches a key, especially with a bucket having several collisions. A new hash table entry called a “cumulative node” is introduced, which stores keys into a “key table” within the entry and includes pointers to metadata associated with the keys. The number of entries stored in the cumulative node depends on the size of the cumulative node, key size, and the size of the pointer type.

### BACKGROUND

### Field

This disclosure relates generally to hash table searching, and more specifically, to improving hash search throughput by reducing the number of direct memory access operations.

### Related Art

In computing, a hash table is a data structure that implements an associative array abstract data type that maps keys to values. A hash function is used to compute an index into an array of buckets or entries, from which the desired value can be found. One reason for using a hash table is that the average cost for each lookup is independent of the number of elements stored in the table, excluding conflicts.

Hash tables are therefore used in many kinds of computer software applications, particularly for associative arrays, database indexing, caches, and sets. For example, a network router can use a hash table data structure for storage of a forwarding information base (FIB) routing table that links content names with an output interface. A hash of the content name can be used during packet forwarding as an index to the table containing the content name/output interface pairs.

Typically, a hash table array stores a pointer to the head of an open-ended link list of all entries whose keys produce the same index when the hash is computed. This array is called a “hash bucket.” The hash value can be calculated based on a key value using any hashing algorithm. The computer hash index may be large and can be masked with a value that represents a manageable table size. Uniqueness of the hash is dependent upon the hash algorithm and number of buckets in the hash table, which in turn determines how many bits of the hash value get into a bucket. A large hash table and an efficient hash algorithm can reduce the number of hash collisions. But practically it is not possible to have a collision free hash table.

Computing the hash and searching the hash table for the pointer at the beginning of the hash bucket is designed to be efficient. But traversal of the linked list of entries to find the exact match can be a performance bottleneck, especially where there are many collision entries and the matching entry is farthest down the linked list from the head. While hash tables can be employed in environments where the processor core traversing the list has direct access to the table entries during the match operation, hash tables are also used in constrained environments where the core needs to use direct memory access (DMA) operations to read the collision entries prior to key comparison. DMA operations are not synchronous and can lead to the core stalling or waiting for the read to complete and leads to significant reduction in performance during lookup. It is therefore desirable to have a hash table data structure that includes the benefits of quick search through the table while at the same time reducing a number of DMA operations to find the entry matching the key.

### BRIEF DESCRIPTION OF THE DRAWINGS

Embodiments of the present invention may be better understood by referencing the accompanying drawings.

FIG. 1 is a simplified block diagram illustrating a multi-core processor configurable to incorporate embodiments of the present invention.

FIG. 2 is a simplified block diagram illustrating a typical hash table and collision list.

FIG. 3 is a simplified block diagram illustrating an example of a cumulative node in accord with one embodiment of the present invention.

FIG. 4 is a simplified block diagram illustrating a single entry for a hash bucket in accord with embodiments of the present invention.

FIG. 5 is a simplified flow diagram illustrating a method for insertion of new entries to a hash bucket of a table used in a hybrid hash approach in accord with embodiments of the present invention.

FIG. 6 is a simplified flow diagram illustrating a method for searching for matching keys in a table used in a hybrid hash approach in accord with embodiments of the present invention.

FIG. 7 is a simplified flow diagram illustrating a method for deleting an entry from a hybrid hash table in accord with embodiments of the present invention.

FIG. 8 is a simplified block diagram illustrating a network routing device configurable to incorporate embodiments of the present invention.

The use of the same reference symbols in different drawings indicates identical items unless otherwise noted. The figures are not necessarily drawn to scale.

### DETAILED DESCRIPTION

Embodiments of the present invention provide a hash table data structure that reduces the number of DMA operations, and if possible, the number of key comparisons, needed to traverse the table entries to find an entry that matches a key, especially with a bucket having several collisions. Embodiments do this by introducing a new hash table entry called a “cumulative node” that stores keys into a “key table” within the entry and includes pointers to metadata associated with the keys. The number of entries stored in the cumulative node depends on the size of the cumulative node, key size, and the size of the pointer type.

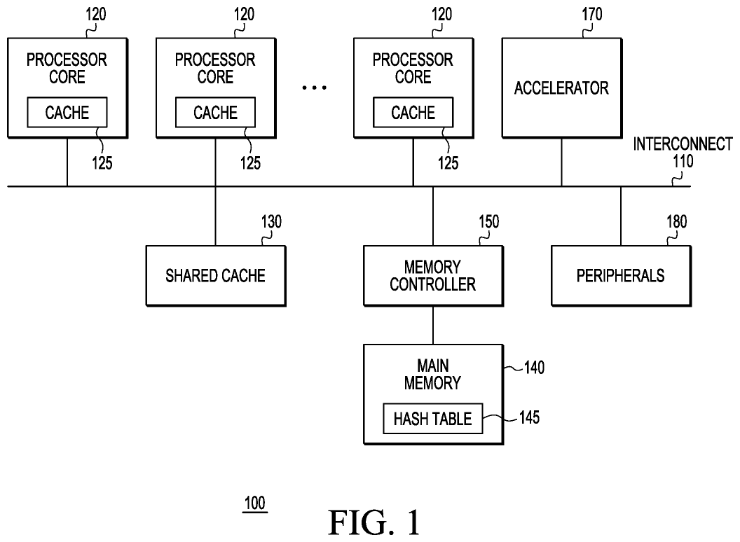

FIG. 1 is a simplified block diagram illustrating a multi-core processor 100 configurable to incorporate embodiments of the present invention. A system interconnect 110 communicatively couples all illustrated components of the multi-core processor. A set of processor cores 120 are coupled to system interconnect 110. Each processor core includes at least one local cache memory 125. Local cache memory 125 can store program instructions and data that are used repeatedly in the operation of programs or information that the associated processor core is likely to need next. Local cache memory 125 can include, for example, L1 and L2 levels of cache memory. The processor core can access the information more quickly from the cache memory than retrieving the information from the main memory, thereby increasing the overall speed of program execution. In addition, a shared cache 130 can be coupled to processor cores 120 via system interconnect 110. This multilevel cache still provides faster access to data than accessing the main memory but can store information that is less used by the processor cores (e.g., an L3 cache). In addition, as illustrated, shared cache 130 is accessible to all the processor cores and therefore can store information usable by each processor core.

Main memory 140 is also coupled to the system interconnect 110 and accessible via a memory controller 150. The main memory is typically random-access memory (RAM) in which the operating system and application programs are stored. As illustrated, one or more hash tables 145 are stored in main memory 140.

Accelerators 170 and peripherals or peripheral controllers 180 can be communicatively coupled to interconnect 110, which allows communication with the processor cores. Accelerators 170 can include, for example, circuitry to perform security tasks, queue management, and buffer management. Peripherals 180 can include, for example, circuitry to perform power management, flash management, interconnect management, USB, and other PHY type tasks.

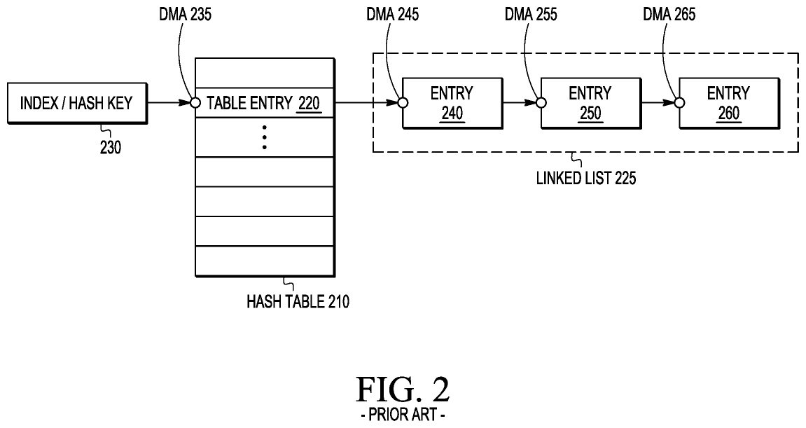

FIG. 2 is a simplified block diagram illustrating a typical hash table and collision list. Hash table 210 contains a set of table entries 220. Each table entry includes a key value and a pointer to the first entry in an associated linked list 225. A hash key is used to generate an index 230 by a hash algorithm. Index 230 is used to identify the appropriate table entry 220 in hash table 210. The table entry 220 is accessed by DMA 235. In order to find the exact match to the hash key, the first entry (entry 240) in linked list 225 is accessed using the pointer from table entry 220 with DMA 245. If a key value in entry 240 does not exactly match the hash key, then entry 250 is accessed using DMA 255. This continues down the linked list (e.g., accessing entry 260 via DMA 265) until an exact match for the key value is found.

So the further the linked list is traversed, the more DMA operations are used. In the above example, the number of DMA operations used to match an entry will be 1+collision entry position in the collision list. These multiple DMA operations can lead to significant performance reductions during lookup operations.

In order to reduce the performance degradation caused by DMA operations during hash table lookup, embodiments of the present invention introduce a cumulative node hash table entry. The cumulative node provides keys in a key table stored in the cumulative node and pointers to associated metadata. This avoids the typical approach in which the key and metadata are stored in the same entry and a mis-compare of the stored key results in a DMA operation to fetch the next entry holding the next key value. A number of entries stored in the cumulative node depends on the size of the cumulative node, key size, and the size of the pointers stored within the cumulative node.

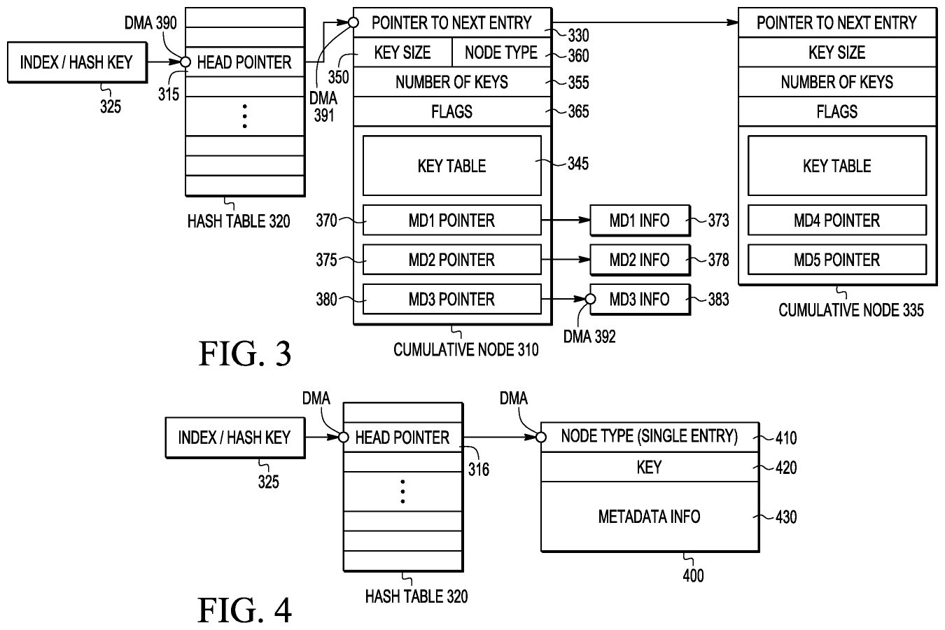

FIG. 3 is a simplified block diagram illustrating an example of a cumulative node 310 in accord with one embodiment of the present invention. The cumulative node is accessed by a head pointer 315 stored in a hash bucket of hash table 320, which is referenced by index 325 generated by a hash algorithm on a hash key. Cumulative node 310 can include a pointer to the next entry (e.g., a next cumulative node 335) and a key table 345, which will be described in greater detail below. In addition, cumulative node 310 can include information regarding key table 345, such as the size of the keys stored in the key table (i.e., key size 350) and a number of keys in the key table (i.e., number of keys 355). A node type descriptor 360 can be included to distinguish the cumulative node from other types of node entries in the hash table, as will be discussed below. Additional flags 365 can be stored in the cumulative node, as desirable for the application using the hash table.

Key table 345 is formed from the keys of multiple hash table entries that are combined into the cumulative node. The entries in the key table depend upon requirements of the module search implementation. These entries can include, for example, concatenated keys of multiple single entries in the hash table, concatenated padded keys of each single entry, and hash-based keys values of each single entry (e.g., instead of storing the direct key, the hash value of the key is stored). In environments where more than one type of entry may be found in differing cumulative nodes in a single hash table, the cumulative node may also include information about the type of key table entry (e.g., hash-based, padded, or plain keys) in addition to a key size 350. In addition, the key table can include reserved characters if required by the key search algorithm.

Since a limited number of entries can be held in each cumulative node key table, multiple cumulative nodes can be chained into an open-ended list using pointers 330. In this case, data stored in cumulative node 335 is similar to that discussed for cumulative node 310 but for the additional keys.

Each cumulative node also stores a set of pointers to metadata associated with the table entry (i.e., similar to the information that would have been stored in a prior art hash table entry). Once a matching key is found in the cumulative node, the corresponding pointer is referenced (e.g., pointers 370, 375, and 380) and the pointer information is provided for subsequent access to the stored data (e.g., metadata information storage locations 373, 378, and 383).

Through the use of a cumulative node, such as cumulative node 310, a number of DMAs to access metadata referenced by an entry late in a collision chain can be reduced over prior art methods. For example, only three DMAs are needed to access metadata information associated with the third entry of key table 345 in cumulative node 310 (i.e., DMA 390, 391, and 392), reducing the number of DMAs by two. Further reductions are realized by longer key tables and chained cumulative nodes.

While cumulative nodes provide a performance improvement when there are collision entries, a cumulative node may result in a performance degradation when there is only one entry in a hash bucket. This is due to an additional DMA needed to access the metadata associated with the entry, rather than having the metadata within the entry node itself as in the prior art. In order to address this issue, embodiments of the present invention can use a hybrid hash approach where the hash table includes both single entries and cumulative entries.

FIG. 4 is a simplified block diagram illustrating a single entry 400 for a hash bucket in accord with embodiments of the present invention providing a hybrid hash table. As illustrated, head pointer 316 in hash table 320 points to a single entry data structure. Single entry 400 includes a type identifier field 410 that identifies the entry as a single entry; that is, containing only information related to one key, and not several as in a cumulative entry. The single entry also includes a key 420, which is the only key referenced by the single entry, and metadata information 430 associated with the key. When hash key resolution is performed on a hash bucket containing head pointer 316, the single entry is accessed and identified as such through reading identifier field 410. Subsequently, the key is examined and the metadata is accessed as appropriate for the single entry.

The hybrid hash approach addresses what happens when a second entry is added to the same hash bucket as a single entry. In such a case, as will be discussed in greater detail below, a cumulative node is allocated. The key of the existing single entry is added to the key table of the new cumulative node, and a pointer to the metadata of the single entry is added to the cumulative node. In addition, the key for the second entry also will be included as an entry in the key table of the cumulative node, along with a pointer to metadata associated with the second entry. The hash bucket head pointer will then be modified to point to the cumulative node, rather than the single entry. In this manner, key matching performance is optimized for hash buckets having both a single entry in a hash bucket and collision entries.

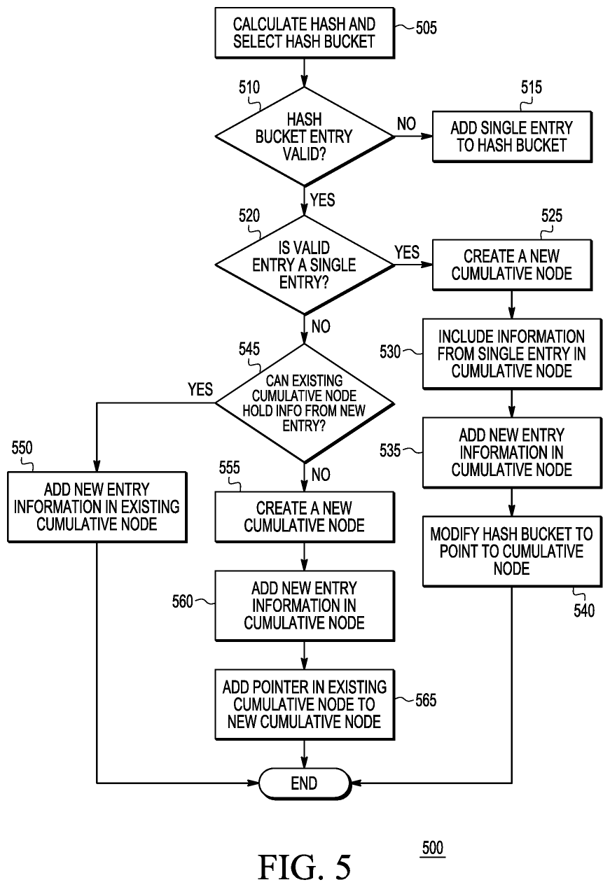

FIG. 5 is a simplified flow diagram illustrating a method for insertion of new entries to a hash bucket of a table 500 used in the above hybrid hash approach in accord with embodiments of the present invention. For a key value associated with the new entry, a hash value is calculated and a hash bucket corresponding to the hash value is selected (505). A determination is then made as to whether the hash bucket has a valid entry (510). If no valid entry is present for the hash bucket, then a single entry (e.g., single entry 400) is added to the hash bucket (515). As discussed above, the single entry data structure can be populated with the key value used to generate the hash value, a value identifying the entry as a single entry, and the metadata associated with the entry.

If a valid entry is present for the hash bucket, then a determination is made as to whether the valid entry is a single entry (520). If the valid entry is a single entry, then a new cumulative node is generated to contain information related to the valid entry and the new entry (525). Information from the valid single entry is copied into the data structure of the cumulative node (530). For example, based on the key table type of the cumulative node, a key or padded key or hash value of the single entry is added to the key table portion of the cumulative node. A pointer is also added to the cumulative node, pointing to the metadata information originally stored in the single entry. In addition, information related to the new entry is also stored in the appropriate locations of the cumulative node (e.g., key-related information and a pointer to a storage location of the associated metadata for the new entry) (535). Once the cumulative node has been populated with the information related to the single entry and the new entry, the hash bucket associated with the hash key is modified to point to the cumulative node (540).

If the valid entry present for the hash bucket is not a single entry (520), that is, the valid entry is a cumulative node, then a determination is made as to whether the existing cumulative node can hold the additional information related to the new entry (545). If the existing cumulative node can hold that information based upon the size restrictions of the cumulative node, then the new entry information is added to the key table and metadata pointer list of the existing cumulative node (550).

If the existing cumulative node does not have sufficient space to hold information related to the new entry (545), then a new cumulative node is created having characteristics similar to that of the existing cumulative node (555). The information related to the new entry (e.g., key-related information and metadata pointer) is added in the appropriate storage areas of the new cumulative node (560). A pointer to the new cumulative node is then added in the existing cumulative node (565).

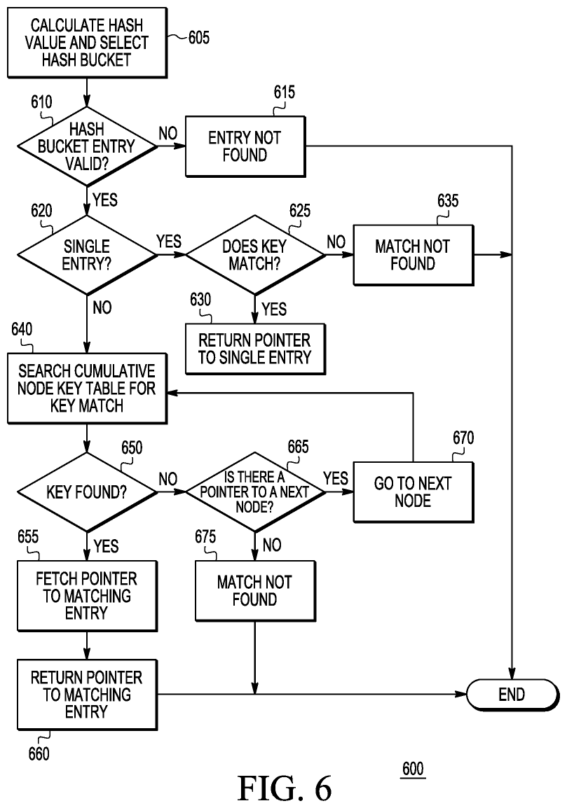

FIG. 6 is a simplified flow diagram illustrating a method 600 for searching for matching keys in a table used in the above hybrid hash approach in accord with embodiments of the present invention. For a key value, an index hash value is calculated and a hash bucket corresponding to the index is selected (605). A determination is then made as to whether the hash bucket has a valid entry (610). If there is no valid entry, then a status of no entry found can be returned (615). In response to no entry being found as a result of the search, the calling program can proceed in a manner determined by the nature of the application. In some cases, the calling program can proceed to add a new entry to the table using, for example, the flow of FIG. 5.

If a hash bucket entry is found corresponding to the index, a determination is made as to whether the entry is a single entry or a cumulative entry (620). If the entry is a single entry, then a determination is made as to whether the key in the single entry matches the key value being searched upon (625). If there is a match, then the pointer to the single entry is returned (630). If there is not a match, then a status of match not found can be returned (635). In response to no match being found in the existing single entry, the calling program can proceed in a manner appropriate to the nature of the application.

If the hash bucket entry corresponding to the index is a cumulative entry (620), then a search is made of the cumulative entry key table for a key match (640). The search that is conducted is appropriate for the type of the keys in the key table (e.g., hash based, padded key, or a plain key). In case of a plain key or padded key, key comparison is performed directly. In the case of a hash-based key table, the hash value is compared against the hash-based keys in the table. In the case where the same hash value is associated with multiple keys, the first matching node of the hash value is fetched and a comparison is made of the key, until a matching node is found. With each type of key table, if a matching key is found in the key table (650), then a pointer to the matching entry is fetched from the cumulative node (655) and that pointer is returned (660).

If the matching key is not found in the key table (650), then a determination is made of whether a pointer to a next cumulative node is present in the current cumulative node (665). If there is a pointer to a next cumulative node, then the process of searching is repeated for that linked cumulative node (670). If there is no pointer to a next cumulative node (665), then a status of match not found can be returned (675). In response to no match being found in the existing cumulative node or nodes, the calling program can proceed in a manner appropriate to the nature of the application.

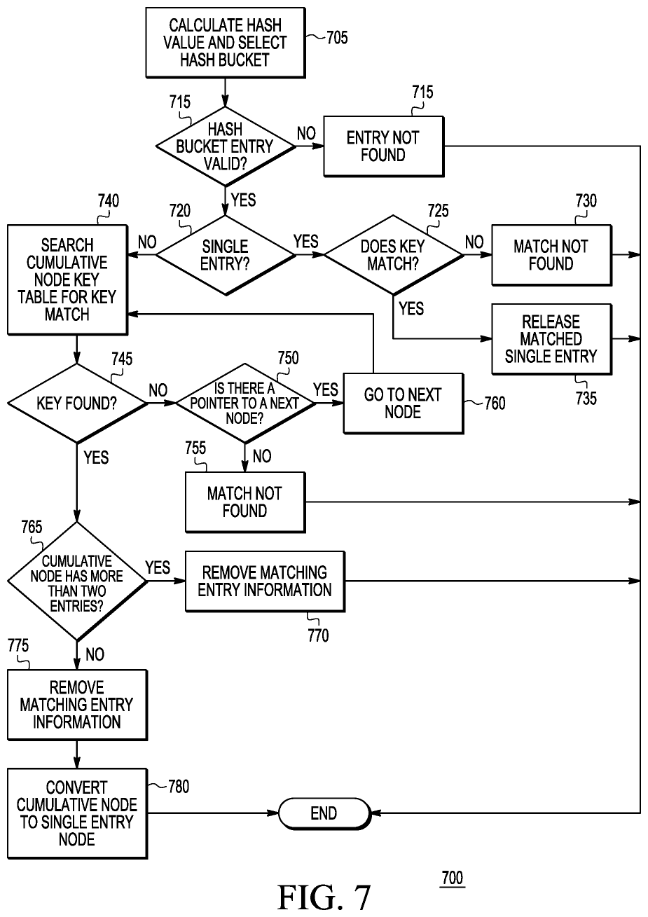

FIG. 7 is a simplified flow diagram illustrating a method 700 for deleting an entry from a hybrid hash table in accord with embodiments of the present invention. For a key value, an index hash value is calculated and a hash bucket corresponding to the index is selected (705). A determination is then made as to whether the hash bucket has a valid entry (710). If there is no valid entry, then a status of no entry found can be returned (715).

If a hash bucket entry is found corresponding to the index, a determination is made as to whether the entry is a single entry or a cumulative node (720). If the entry is a single entry, then a determination is made as to whether the key in the single entry matches the key value being searched upon (725). If there is not a match, then a status of match not found can be returned (730). If there is a match, then the matching single entry can be released (735). For example, the pointer in the hash bucket to the single entry can be deleted and the bucket head pointer can be updated to point to any remaining entries in the hash bucket.

If the entry is a cumulative entry (720), then the key table of the cumulative node can be searched for a match to the key (740). As discussed above with regard to the plain key, padded key, and hash-based key tables, the type of search may be different depending upon the type of key values stored in the key table. If a matching key is not found in the key table (745), then a determination can be made as to whether there is a pointer to a next cumulative node (750). If there is a next cumulative node, then the next cumulative node is accessed (760) and the process of searching the key table repeats for that cumulative node. If there is no pointer to a next cumulative node (750), then a status of match not found can be returned (755).

If there is a matching key in the cumulative node (745), then a determination can be made as to whether the cumulative node has more than two entries (765). Such a determination is made because if the cumulative node has only two entries, the cumulative node can be revised to a single entry to take advantage of the fewer DMA operations needed to access a single entry, as discussed above. If the cumulative node has more than two entries, then the matching entry information is removed from the cumulative node (770). This can be done, for example, by modifying the existing cumulative node to remove the matching entry information from the key table and the pointer listing. Alternatively, a new cumulative node can be allocated and all the common information from the previously existing cumulative node can be copied to the new cumulative node. In addition, all keys and pointer information from the previously existing cumulative node can be copied to the new cumulative node, with the exception of the key(s) and pointer information corresponding to the matching flow. The entry count in the new cumulative node can be updated to reflect the deleted entry information. Finally, in this alternative process, the pointer pointing to the previously existing cumulative node is modified to point to the new cumulative node. This pointer can be either in the hash bucket or another cumulative node ahead of the new cumulative node in a linked list.

If the cumulative node has only two entries (765), then the matching entry information can be removed from the cumulative node, as discussed above (775). Since the cumulative node now will only have one entry, the node can be converted to a single entry node (780). For example, the entry information in the cumulative node can be placed in a new single entry and the hash bucket can directly point to the new single entry.

Embodiments of the present invention provide improved performance of the systems upon which they are employed. In one example, an embodiment of the present invention is provided on a network router to manage a routing table and lookups to the same. Times to resolve collisions in the routing table are presented in the below table.

| | IP route throughput before code | | | | IP route throughput after code | | | |
|---|---|---|---|---|---|---|---|---|
| | modifications (Gbps) | | | | modifications (Gbps) | | | |
| Collisions | 64 B | 412 B | 512 B | 1500 B | 64 B | 412 B | 512 B | 1500 B |
| 0 | 4.322 | 19.999 | 19.999 | 19.999 | 4.300 | 19.999 | 19.999 | 19.999 |
| 1 | 4.059 | 18.733 | 19.999 | 19.999 | 4.091 | 18.784 | 19.999 | 19.999 |
| 2 | 3.858 | 17.523 | 19.999 | 19.999 | 4.080 | 18.748 | 19.999 | 19.999 |
| 3 | 3.666 | 16.729 | 18.748 | 19.999 | 4.057 | 18.782 | 19.999 | 19.999 |
| 4 | 3.585 | 15.935 | 17.384 | 19.999 | 4.080 | 18.784 | 19.999 | 19.999 |
| 5 | 3.488 | 15.345 | 16.828 | 19.999 | 4.075 | 18.779 | 19.999 | 19.999 |
| 6 | 3.431 | 14.937 | 16.194 | 19.999 | 4.043 | 18.612 | 19.999 | 19.999 |
| 7 | 3.372 | 14.572 | 15.757 | 19.999 | 4.080 | 18.704 | 19.999 | 19.999 |
| 8 | 3.335 | 14.209 | 15.337 | 19.999 | 4.084 | 18.803 | 19.999 | 19.999 |
| 9 | 3.267 | 13.972 | 14.989 | 19.999 | 4.090 | 18.734 | 19.999 | 19.999 |

For both the “before” and “after” portions of the table, a single bucket hash table was used to show how much time it takes to traverse collisions in a hash bucket. The table shows throughput times for different size packets in light of the number of collisions that need to be resolved. The “before” section uses a prior art table in which packet flow entries are single entries in the hash table bucket. The prior art method shows a 25-30% decrease in throughput as the number of collisions rise from 0 to 9. The “after” section uses an embodiment of the present invention in which packet flow entries are either single entries or cumulative entries in a hybrid hash table. The implementation of the present method shows a 0-6.3% decrease in throughput as the number of collisions rise from 0 to 9. Further, the drop-off in throughput performance for the present method is largely due to the transition from zero collisions to one collision. This is due to a difference in the number DMAs needed for the single entry in a hash bucket for zero collisions (i.e., one DMA) versus the number of DMAs needed for the cumulative entry for anything more than zero collisions (i.e., two DMA).

In light of the above, use of embodiments of the present invention will improve performance of routers and other devices having hash table lookups, especially in cases where there are a significant number of collisions in hash resolution. As has been noted above, this is due to the reduction in the number of direct memory accesses performed when utilizing the cumulative nodes of embodiments of the present invention.

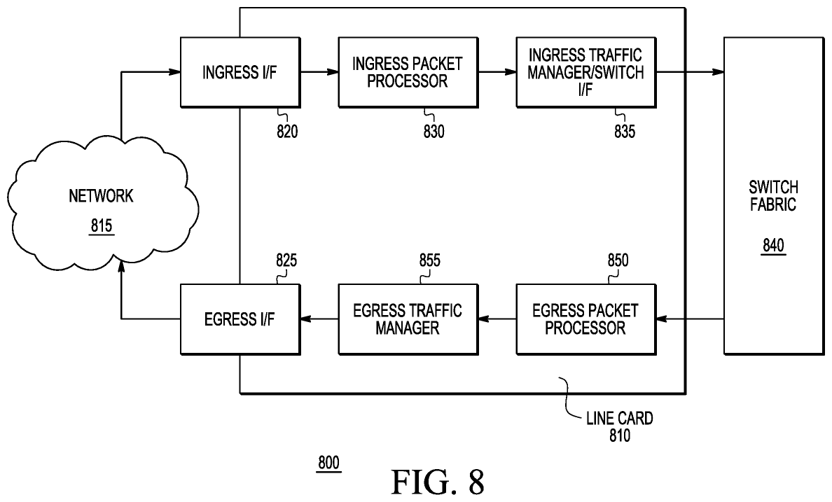

FIG. 8 is a simplified block diagram illustrating a network routing device 800 configurable to incorporate embodiments of the present invention. Network routing device 800 includes a set of line cards 810 and a switch fabric 840. Each line card 810 includes one or more ingress interfaces 820 and one or more egress interfaces 825. As will be understood, the ingress interfaces and the egress interfaces can be implemented in shared circuitry such as a shared port adapter, which include one or more physical interfaces to a network 815 and are configured to perform operations on ingress and egress frames, such as OSI Layer 2.

Ingress interface 820 provides incoming packets to ingress packet processor 830. The ingress packet processor can be a multi-processing, multi-pipelined processor configured to perform a series of operations on incoming packets, such as multi-core processor 100 in FIG. 1. The ingress packet processor can perform analysis of incoming packet headers and support edge features such as classification and flow statistics based upon information in headers. The ingress packet processor can perform analysis on protocols such as IPv4, IPv6, and MPLS packets. Such protocol processing can include the processing associated with routing and hash tables described above, wherein the routing tables can include the hybrid hash tables of embodiments of the present invention. The hash table buckets can reference single flow entries and cumulative entries that reference multiple flows in the key tables described above. Ingress Traffic Manager/Switch Interface 835 receives the processed packets from ingress packet processor 830 and can then perform packet buffering, queue management, ingress traffic shaping, and packet dropping. The ingress traffic manager/switch interface 835 can then prepare the packet for transmission through switch fabric 840 (e.g., uniform, identified cells).

Once the packets are transmitted through switch fabric 840, egress packet processor 850 reassembles the switch fabric cells into packets and performs additional protocol driven operations on the packets, include fragmenting the packets if necessary for the coupled network. The egress packet processor then provides the outgoing packets to egress traffic manager 855, which prepares the packets for transmission and queues the packets to egress interface 825. Egress interface 825 formats the packets appropriately for the physical network coupled to the line card and transmits the packets to network 815.

By now it should be appreciated that there has been provided a network routing device that includes a processor core and a memory coupled to the processor core. The processor core is configured to generate a hash value from a key and use the hash value as an index to access a hybrid hash table. The memory is stores the hybrid hash table. The hybrid hash table includes one or more buckets, where each bucket corresponds to an index value. A first bucket of the one or more buckets stores a first pointer to a single entry node that includes information related to one key. A second bucket of the one or more buckets stores a second pointer to a cumulative node that includes information related to a plurality of keys.

In one aspect of the above embodiment, the cumulative node includes a key table and a plurality of pointers to entry metadata. The key table stores key-related information associated with the plurality of keys. Each of the plurality of pointers is associated with a corresponding key of the plurality of keys. In a further aspect, the key table can store one of plain keys, padded keys, and hash-based keys. In a still further aspect, the cumulative node further includes an indication of the type of entries stored in the key table. In another aspect, the cumulative node further includes a pointer to a linked cumulative node. In still another aspect, the cumulative node further includes an indication of a size of the keys stored in the key table. In yet another aspect, the cumulative node further includes an indication of a number of keys stored in the key table.

Another embodiment provides a method for accessing a hash table referencing one or more single entry nodes and one or more cumulative entry nodes. The method includes calculating an index to the hash table using a key value, selecting a hash bucket stored in the hash table corresponding to the index, determining whether the hash bucket references a single entry node or a cumulative entry node if the hash bucket has a valid entry, searching a first key table in a first cumulative entry node for a match to the key value if the hash bucket references the first cumulative entry node. The embodiment further provides, if there is no match to the key value in the first key table of the first cumulative entry node, for determining if the first cumulative entry node includes a pointer to a second cumulative entry node, and searching a second key table stored in the second cumulative entry node for a match to the key value if the first cumulative entry node includes a pointer to the second cumulative entry node. The single entry node includes information related to a single key value and the cumulative entry node includes information related to a plurality of key values.

In one aspect of the above embodiment, the method further includes fetching a pointer to metadata associated with a matching entry, if the first or second key table includes a matching entry to the key value. The pointer is stored in the cumulative entry node and the pointer is returned. In another aspect of the above embodiment, the method further includes returning an indication that a match was not found if no matching entry to the key value is found in one of the key tables.

In another aspect of the above embodiment, the method further includes, if no matching entry to the key value is found in the first or second key table, determining if a present cumulative node has sufficient space to store information related to a new entry corresponding to the key value, and adding information related to the new entry corresponding to the key value to the present cumulative node if the present cumulative node has sufficient space. The information includes an entry in the key table of the cumulative node and a pointer to metadata corresponding to the key value. In a further aspect, if the present cumulative node does not have sufficient space to store the new entry, then the method provides for creating a new cumulative node, adding information related to the new entry corresponding to the key value in the new cumulative node, and adding a pointer to the new cumulative node in the present cumulative node.

In another aspect of the above embodiment, the method further includes determining if the key value matches the single key value if the hash bucket references the single entry node, returning a pointer to the single entry node if the key value matches, and returning an indication that a match was not found, if the key value does not match. In yet another aspect of the above embodiment, the method includes determining if the key value matches the single key value if the hash bucket references the single entry node, returning a pointer to the single entry node if the key value matches. If the key value does not match, then the method provides for: creating a new cumulative node; adding, to the new cumulative node, information from the single entry node related to the entry included in the single entry node; adding, to the new cumulative node, information related to a new entry corresponding to the key value; storing a pointer to the new cumulative node in the hash bucket; and, removing the single entry node.

In another aspect of the above embodiment, if the first or second key table includes a matching entry to the key value, then the method further provides for deleting information corresponding to the matching entry from a present cumulative node, and converting the present cumulative node to a single entry node if the present cumulative node includes two entries prior to said deleting. In yet a further aspect of the above embodiment, the method provides for deleting a single entry by determining if the key value matches the single key value if the hash bucket references a single entry node, releasing the matched single entry node if the key value matches, and returning an indication that a match was not found if the key value does not match.

Another embodiment provides for a network routing device that includes a processor core and a memory coupled to the processor core. The processor core is configured to generate a hash value from a key and use the hash value as an index to access a routing table that includes a hybrid hash table. The memory stores the routing table. The routing table includes one or more hash buckets that each correspond to an index value. A first hash bucket of the hash buckets stores a first pointer to a flow entry that includes information related to one flow associated with a corresponding key. A second hash bucket of the hash buckets stores a second pointer to a cumulative node that includes information related to a plurality of flows associated with corresponding keys. The cumulative node includes a key table that stores key-related information associated with the keys and a plurality of pointers to flow metadata where each of the pointers is associated with a corresponding key.

In one aspect of the above embodiment, the processor core is configured to receive a network data packet that includes a source address, a destination address, a protocol identifier, and an IP identifier, and to generate the key from a tuple that includes the source address, the destination address, the protocol identifier, and the IP identifier. The routing table includes entries associated with network data flows corresponding to information from previously received network data packets. In a further aspect, the processor core is further configured to: select a hash bucket stored in the hash table corresponding to the hash value; determine whether the hash bucket references a flow entry or a cumulative node if the hash bucket has a valid entry; search a first key table stored in a first cumulative node for a match to the key value if the hash bucket references the first cumulative node; if there is not match to the key value in the first key table of the first cumulative node, then determine if the first cumulative node includes a pointer to a second cumulative node, and search a second key table stored in the second cumulative node for a match to the key value if the first cumulative node includes a pointer to the second cumulative node; if the first or second key table include a matching entry to the key value, then fetch the pointer to the metadata associated with the matching key table entry, and return the pointer; access flow-related information stored in the pointer; and, direct the network data packet through the network routing device to a line card associated with the flow.

In another embodiment, a method is provide for updating a hash table referencing one or more single entry nodes and one or more cumulative nodes. The method includes: calculating an index to the hash table using a key value; selecting a hash bucket stored in the hash table corresponding to the index; if the hash bucket has a valid entry, determining whether the hash bucket references a single entry node or a cumulative entry node, wherein the single entry node comprises information related to a single key value, and the cumulative entry node comprises information related to a plurality of key values; and if the hash bucket references a cumulative entry node, determining if a present cumulative node has sufficient space to store information related to a new entry corresponding to the key value, and adding information related to the new entry corresponding to the key value to the present cumulative node if the cumulative node has sufficient space, wherein the information comprises an entry in the key table of the cumulative node and a pointer to metadata corresponding to the key value.

In one aspect of the above embodiment, if the present cumulative node does not have sufficient space to store the new entry, the method further provides for creating a new cumulative node, adding in the new cumulative node information related to the new entry corresponding to the key value, and adding a pointer to the new cumulative node in the present cumulative node. In another aspect of the above embodiment, if the hash bucket has no valid entry, the method further provides for adding a new single entry node to the hash bucket. In yet another aspect of the above embodiment, if the hash bucket references a single entry node, the method further provides for: creating a new cumulative node; adding, in the new cumulative node, information from the single entry node related to the entry comprised in the single entry node; adding, in the new cumulative node, information related to a new entry corresponding to the key value; storing a pointer to the new cumulative node in the hash bucket; and removing the single entry node.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

Some of the above embodiments, as applicable, may be implemented using a variety of different information processing systems. For example, although FIGS. 1 and 8 and the discussion thereof describe an exemplary information processing architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

All or some of the components described herein may be received elements of routing device 800 or multi-core processor 100, for example, from computer readable media such as memory 140 or other media on other computer systems. Such computer readable media may be permanently, removably or remotely coupled to an information processing system such as routing device 800. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, and the like.

Although the invention is described herein with reference to specific embodiments, various modifications and changes can be made without departing from the scope of the present invention as set forth in the claims below. For example, improvements to hash collision resolution are applicable to not only network routing, but to other applications, as well. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A network routing device comprising:
a processor core configured to generate a hash value from a key and use the hash value as an index to access a hybrid hash table;
a memory, coupled to the processor core, and storing the hybrid hash table, wherein
the hybrid hash table comprises one or more buckets each corresponding to an index value,
a first bucket of the one or more buckets stores a first pointer to a single entry node that comprises information related to one key, and
a second bucket of the one or more buckets stores a second pointer to a cumulative node that comprises information related to a plurality of keys.

2. The network routing device of claim 1 wherein the cumulative node comprises:
a key table storing key-related information associated with the plurality of keys; and
a plurality of pointers to entry metadata, wherein each of the plurality of pointers is associated with a corresponding key of the plurality of keys.

3. The network routing device of claim 2 wherein the key table can store one of plain keys, padded keys, and hash-based keys.

4. The network routing device of claim 3 wherein the cumulative node further comprises an indication of the type of entries stored in the key table.

5. The network routing device of claim 2 wherein the cumulative node further comprises a pointer to a linked cumulative node.

6. The network routing device of claim 2 wherein the cumulative node further comprises an indication of a size of the keys stored in the key table.

7. The network routing device of claim 2 wherein the cumulative node further comprises an indication of a number of keys stored in the key table.

8. A method for accessing a hash table referencing one or more single entry nodes and one or more cumulative entry nodes, the method comprising:
calculating an index to the hash table using a key value;
selecting a hash bucket stored in the hash table corresponding to the index;
if the hash bucket has a valid entry, determining whether the hash bucket references a single entry node or a cumulative entry node, wherein
the single entry node comprises information related to a single key value, and
the cumulative entry node comprises information related to a plurality of key values;
searching a first key table stored in a first cumulative entry node for a match to the key value if the hash bucket references the first cumulative entry node; and
if there is no match to the key value in the first key table of the first cumulative entry node, then
determining if the first cumulative entry node comprises a pointer to a second cumulative entry node, and
searching a second key table stored in the second cumulative entry node for a match to the key value if the first cumulative entry node comprises a pointer to the second cumulative entry node.

9. The method of claim 8 further comprising:
if the first or second key table comprises a matching entry to the key value, then fetching a pointer to metadata associated with the matching entry, wherein the pointer is stored in the cumulative entry node, and returning the pointer.

10. The method of claim 8 further comprising:
returning an indication that a match was not found if no matching entry to the key value is found in one of the key tables.

11. The method of claim 8 further comprising:
if no matching entry to the key value is found in the first or second key table, then
determining if a present cumulative node has sufficient space to store information related to a new entry corresponding to the key value, and
adding information related to the new entry corresponding to the key value to the present cumulative node if the present cumulative node has sufficient space,
wherein the information comprises an entry in the key table of the cumulative node and a pointer to metadata corresponding to the key value.

12. The method of claim 11, if the present cumulative node does not have sufficient space to store the new entry, further comprising:
creating a new cumulative node;
adding, in the new cumulative node, information related to the new entry corresponding to the key value; and
adding a pointer to the new cumulative node in the present cumulative node.

13. The method of claim 8 further comprising:
determining if the key value matches the single key value, if the hash bucket references the single entry node;
returning a pointer to the single entry node, if the key value matches; and
returning an indication that a match was not found, if the key value does not match.

14. The method of claim 8 further comprising:
determining if the key value matches the single key value, if the hash bucket references the single entry node;
returning a pointer to the single entry node, if the key value matches; and
if the key value does not match, then
creating a new cumulative node,
adding, in the new cumulative node, information from the single entry node related to the entry comprised in the single entry node,
adding, in the new cumulative node, information related to a new entry corresponding to the key value,
storing a pointer to the new cumulative node in the hash bucket; and
removing the single entry node.

15. The method of claim 8 further comprising:
if the first or second key table comprises a matching entry to the key value, then
deleting information corresponding to the matching entry from a present cumulative node, and
converting the present cumulative node to a single entry node, if the present cumulative node comprises two entries prior to said deleting information.

16. The method of claim 8 further comprising:
determining if the key value matches the single key value, if the hash bucket references the single entry node;
releasing the matched single entry node, if the key value matches; and
returning an indication that a match was not found, if the key value does not match.

17. A network routing device comprising:
a processor core configured to generate a hash value from a key and use the hash value as an index to access a routing table, wherein the routing table comprises a hybrid hash table;
a memory, coupled to the processor core, and storing the routing table, wherein
the routing table comprises one or more hash buckets each corresponding to an index value,
a first hash bucket of the one or more hash buckets stores a first pointer to a flow entry that comprises information related to one flow associated with a corresponding key, and
a second hash bucket of the one or more hash buckets stores a second pointer to a cumulative node that comprises information related to a plurality flows associated with corresponding keys, wherein the cumulative node comprises a key table storing key-related information associated with the keys and a plurality of pointers to flow metadata where each of the plurality of pointers is associated with a corresponding key.

18. The network routing device of claim 17, wherein
the processor core is configured to
receive a network data packet comprising a source address, a destination address, a protocol identifier, and an IP identifier,
generate the key from a tuple comprising the source address, the destination address, the protocol identifier, and the IP identifier;
the routing table comprises entries associated with network data flows corresponding to information from previously received network data packets.

19. The network routing device of claim 18, wherein the processor core is further configured to:
select a hash bucket stored in the hash table corresponding to the hash value;
if the hash bucket has a valid entry, determine whether the hash bucket references a flow entry or a cumulative node;
search a first key table stored in a first cumulative node for a match to the key value if the hash bucket references the first cumulative node; and
if there is no match to the key value in the first key table of the first cumulative node, then
determine if the first cumulative node comprises a pointer to a second cumulative node, and
search a second key table stored in the second cumulative node for a match to the key value if the first cumulative node comprises a pointer to the second cumulative node;
if the first or second key table comprises a matching entry to the key value, then fetch the pointer to the metadata associated with the matching key table entry, and
return the pointer;
access flow related information stored in the pointer; and
direct the network data packet through the network routing device to a line card associated with the flow.

20. A method for updating a hash table referencing one or more single entry nodes and one or more cumulative nodes, the method comprising:
calculating an index to the hash table using a key value;
selecting a hash bucket stored in the hash table corresponding to the index;
if the hash bucket has a valid entry, determining whether the hash bucket references a single entry node or a cumulative entry node, wherein
the single entry node comprises information related to a single key value, and
the cumulative entry node comprises information related to a plurality of key values;
if the hash bucket references a cumulative entry node,
determining if a present cumulative node has sufficient space to store information related to a new entry corresponding to the key value, and
adding information related to the new entry corresponding to the key value to the present cumulative node if the cumulative node has sufficient space, wherein the information comprises an entry in the key table of the cumulative node and a pointer to metadata corresponding to the key value.

21 The method of claim 20, if the present cumulative node does not have sufficient space to store the new entry, further comprising:
creating a new cumulative node;
adding, in the new cumulative node, information related to the new entry corresponding to the key value; and
adding a pointer to the new cumulative node in the present cumulative node.

22. The method of claim 20, if the hash bucket has no valid entry, further comprising:
adding a new single entry node to the hash bucket.

23. The method of claim 20, if the hash bucket references a single entry node, further comprising:
creating a new cumulative node;
adding, in the new cumulative node, information from the single entry node related to the entry comprised in the single entry node;
adding, in the new cumulative node, information related to a new entry corresponding to the key value;
storing a pointer to the new cumulative node in the hash bucket; and
removing the single entry node.
